(19) United States
(12) Patent Application Publication
(10) Pub. No.: US 2021/0337903 A1
(43) Pub. Date: Nov. 4, 2021

(54) COMPOSITE FABRIC OF WATER RETENTIVE AND ANTIMICROBIAL MATERIALS FOR SUSTAINED SKIN HYDRATION

(71) Applicant: Pinaki R. Majhi, Sharon, MA (US)

(72) Inventors: Pinaki R. Majhi, Sharon, MA (US); Jaehwan Kim, Cambridge, MA (US); Nelson Ayala, Lynchbur, VA (US)

(73) Assignee: Pinaki R. Majhi, Sharon, MA (US)

(21) Appl. No.: 17/285,796

(22) PCT Filed: Oct. 15, 2019
(86) PCT No.: PCT/US2019/056396

§ 371 Date: Apr. 15, 2021

Related U.S. Application Data
(60) Provisional application No. 62/745,590, filed on Oct. 15, 2018.

(51) Int. Cl. A41D 31/30; A01N 25/34; A01N 33/12; A01N 59/16; A01N 59/06

(52) U.S. Cl. CPC A41D 31/305; A01N 25/34; A01N 59/06; A01N 59/16; A01N 33/12

(57) ABSTRACT

Composite fabric of water retentive and antimicrobial materials for sustained skin hydration. The present disclosure includes disclosure of a composite product, comprising a first material configured to retain liquid and release liquid vapor over time, and a second material having antimicrobial properties, wherein the first material and the second material are combined to form the composite product.

### PRIORITY & RELATED APPLICATION

The present patent application is related to, and claims the priority benefit of, U.S. Provisional Patent Application Ser. No. 62/745,590, filed Oct. 15, 2018, the contents of which are incorporated herein directly and by reference in their entirety.

### BACKGROUND

Atopic dermatitis, otherwise known as eczema, is a chronic inflammatory skin disease that affects 15-30% of children. Patients with atopic dermatitis, whether a child or an adult, commonly experience sleep disturbance due to itching that majorly impairs the quality of life of the patients and their families. The present invention addresses this problem, in relevance to textiles and clothing, as these materials are in contact or close proximity with the user's skin for prolonged periods of time giving them the potential for effectively protecting and facilitating healing of the skin barrier.

Currently, there is no unified standard of care for patients to prevent itching during sleep. A range of methods are being practiced including orally administered antihistamine drugs, application of creams, and wet wrap therapy. Orally administered antihistamine drugs have the effect of preventing inflammation and sedating the user to facilitate the process of going to sleep, but has been known to be marginally effective in preventing or relieving the itching sensation. Certain topical steroids are known to be effective in relieving the itching sensation. However, due to side effects that cause the skin barrier to thin, topical steroids can only be applied sparingly and for no longer than a week.

Wet wrap therapy is a method of hydrating the skin during sleep, where patients soak wraps or a tightly fitting pajama in water and wear them to sleep under another layer of dry pajamas. Wet wrap therapy has been known in the medical community to be effective with minimal side effects. Prolonged hydration of the skin improves eczema treatment outcomes by creating an environment that allows proper functioning of proteases, which alleviate irritation due to allergens or foreign antigens. Additionally, external hydration of the skin promotes proper function of filaggrin, which is the protein that is a critical component of the skin-barrier and is a natural moisturizer. However, wet wraps are considered to be severely uncomfortable especially in regard to its adherence to the skin and the damp feeling it imbues during sleep. Additionally, the process of executing wet wrap therapy is extensive and laborious requiring from 40 minutes to 2 hours and the help of a caregiver to perform. This inconvenience has limited the use of wet wrap therapy despite its efficacy in preventing itching by hydrating and protecting the skin barrier.

### BRIEF SUMMARY

The present disclosure includes disclosure of solutions to this problem by applying super absorbent polymer (SAP) to textiles. SAP is a material that has the ability to retain a relatively considerable amount of liquid for its mass. Traditional consumer hygiene products, such as baby diapers and napkins, have implemented SAP as an absorbent. In agriculture, SAP's ability to retain water and to release its absorbed water has been used for drought resistance. SAP distributed around the crop can absorb rainwater, which keeps it localized near the plant roots, preventing it from penetrating underground. With slight vacuum pressure from the plant roots, SAP easily releases ˜95% of adsorbed water, effectively hydrating the plant in water scarce situations.

While traditional consumer products have implemented SAP as an absorbent, the present disclosure includes disclosure of products that utilize SAP and/or other hydration retention materials around their innate hydration equilibrium points. In this consideration, composite products of the present disclosure can include composite layering that retains the absorbed water or other liquid and diffuses the same in the form of water vapor over a period of time. Hydration of the skin by water vapor dramatically improves comfort over wet wraps, which imbue a damp and sticky feeling to the skin. By shielding one of the surfaces with an overlaying water repelling layer, composite products of the present disclosure are able to ensure sustained hydration of the skin which is in direct or indirect contact with SAP. The water repellent layer also ensures that the outside of the garment stays dry by preventing external seeping, further improving ease of use by eliminating drying and cleaning of bed sheets.

The present disclosure includes disclosure of novel products, including but not limited to novel fabrics, which are configured to allow or facilitate prolonged skin hydration and which has bacteriostatic/antimicrobial properties. These properties are achieved by using a composite fabric consisting of water or other liquid retentive component and an antimicrobial component. At least one embodiment, which may be a preferred embodiment depending on configuration, is in the form of layering, including (in the order away from the skin) a breathable and smooth textile which is antimicrobial, a water (or other liquid) absorbing and retention material, and a hydrophobic outer layer that shields the inner layers and the skin from a foreign agent or material. The fabric will hydrate the skin with water vapor that is released from the water retention material. The smooth and breathable layer allows hydration of the skin without dampening the skin surface. The antimicrobial property of the inner layer prevents dangerous bacterial growth on the skin. In some preferred embodiments, the novel fabric is used as base material of a garment, glove, sock, or bands. Garments will hydrate large areas of or the full body, whereas a glove, sock, or band will hydrate the skin locally.

The present disclosure includes disclosure of a composite product, comprising a first material configured to retain liquid and release liquid vapor over time, and a second material having antimicrobial properties, wherein the first material and the second material are combined to form the composite product. The present disclosure includes disclosure of a composite product, wherein the first material and the second material are woven together to form a single layer of material. The present disclosure includes disclosure of a composite product, wherein the first material and the second material are combined by layering the first material on top of the second material to form a two-layered material.

The present disclosure includes disclosure of a composite product, further comprising a third material having hydrophobic properties, and wherein the third material is combined with the first material and the second material to form the composite product. The present disclosure includes disclosure of a composite product, wherein the first material, the second material, and the third material are combined by layering the first material on top of the second material, and layering the third material on top of the first material, to firm a three-layered material.

The present disclosure includes disclosure of a composite product, wherein the second material comprises lyocell and modal fibers. The present disclosure includes disclosure of a composite product, wherein the second material comprises viscose rayon.

The present disclosure includes disclosure of a composite product, wherein the first material comprises a super absorbent polymer (SAP). The present disclosure includes disclosure of a composite product, wherein the first material comprises a super absorbent fiber (SAF).

The present disclosure includes disclosure of a composite product, formed into a garment configured to cover a majority of a wearer's body. The present disclosure includes disclosure of a composite product, formed into a garment configured to cover part of a wearer's body. The present disclosure includes disclosure of a composite product, wherein the garment is configured to cover a torso of the wearer's body. The present disclosure includes disclosure of a composite product, wherein the garment is configured to cover a leg of the wearer's body. The present disclosure includes disclosure of a composite product, wherein the garment is configured to cover a foot of the wearer's body. The present disclosure includes disclosure of a composite product, wherein the garment is configured to cover an arm of the wearer's body. The present disclosure includes disclosure of a composite product, wherein the garment is configured to cover a hand of the wearer's body. The present disclosure includes disclosure of a composite product, wherein the garment is configured to cover a face of the wearer's body.

The present disclosure includes disclosure of a composite product, further comprising a dyed portion combined with the composite product. The present disclosure includes disclosure of a composite product, wherein the dyed portion comprises a natural dye. The present disclosure includes disclosure of a composite product, wherein the dyed portion has antimicrobial properties. The present disclosure includes disclosure of a composite product, wherein the dyed portion comprises a dye selected from the group consisting of turmeric, indigo, and persimmon fruit dye. The present disclosure includes disclosure of a composite product, wherein the dyed portion comprises a hydrochromic dye, said hydrochromic dye configured to change color based upon an extent of hydration of the first material.

The present disclosure includes disclosure of a composite product, further comprising a quaternary ammonium compound with a silyl functional group derivatized onto the second material to provide the antimicrobial properties to the composite product.

The present disclosure includes disclosure of a composite product, further comprising one or more electrodes or sensors incorporated into the composite product. The present disclosure includes disclosure of a composite product, wherein the one or more electrodes or sensors are configured to obtain data relative to a thickness of the first material using impedance, said thickness indicating an extent of hydration of the first material. The present disclosure includes disclosure of a composite product, wherein the one or more electrodes or sensors are configured to indicate an extent of hydration of the first material.

The present disclosure includes disclosure of a composite product, wherein the antimicrobial properties of the second material are antibacterial properties and antifungal properties. The present disclosure includes disclosure of a composite product, wherein the second material comprises a metal oxide or a metal ionic compound. The present disclosure includes disclosure of a composite product, wherein the metal oxide or the metal ionic compound is selected from the group consisting of zinc oxide, magnesium oxide, zinc carbonate, and magnesium carbonate.

The present disclosure includes disclosure of a composite product, further comprising one or more electrodes or sensors incorporated into the composite product of the garment. The present disclosure includes disclosure of a composite product, comprising part of a system, the system further comprising a mobile device in wireless communication with the one or more electrodes or sensors. The present disclosure includes disclosure of a composite product, wherein the one or more electrodes is/are configured to obtain data relative to the garment and/or the wearer of the garment and configured to transmit said data to the mobile device.

The present disclosure includes disclosure of a composite product, wherein the data is selected from the group consisting of a thickness of the first material, a hydration level of the first material, a temperature of a wearer of the garment, and a humidity relative the wearer of the garment. The present disclosure includes disclosure of a composite product, configured such that if the data indicates a high body temperature of a wearer of the garment, a layer of the garment or a material positioned relative to the garment can be removed to lower a body temperature of the wearer. The present disclosure includes disclosure of a composite product, configured such that if the data indicates a low body temperature of a wearer of the garment, a layer of the garment or a material positioned relative to the garment can be added to raise a body temperature of the wearer. The present disclosure includes disclosure of a composite product, configured such that if the data indicates a high humidity relative to a wearer of the garment, the first material can be replaced to lower a humidity level relative to the wearer. The present disclosure includes disclosure of a composite product, configured such that if the data indicates a low humidity relative to a wearer of the garment, an additional layer of the first material can be added to increase a humidity level relative to the wearer.

The present disclosure includes disclosure of a composite product, or a garment formed thereof, used to treat atopic dermatitis.

### BRIEF DESCRIPTION OF DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a composite product configured as a three-layer fabric, according to an exemplary embodiment of the present disclosure;

FIG. 2 shows a composite product configured as interwoven materials, according to an exemplary embodiment of the present disclosure;

FIG. 3 shows a garment comprising a composite product, according to an exemplary embodiment of the present disclosure;

FIG. 4 shows two garments, one dehydrated and one hydrated, with a hydrochromic dye used as a moisture indicator, according to exemplary embodiments of the present disclosure;

FIG. 5 shows a graph depicting the moisture retention capabilities of a Tencel®+Gelok® embodiment measured over a time period of 1 hour, according to an exemplary embodiment of the present disclosure;

FIG. 6 shows a garment comprising a three-layer composite product and hook and loop fastener closures, according to an exemplary embodiment of the present disclosure;

FIG. 7 shows various garment configurations, according to exemplary embodiments of the present disclosure; and

FIG. 8 shows a system, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

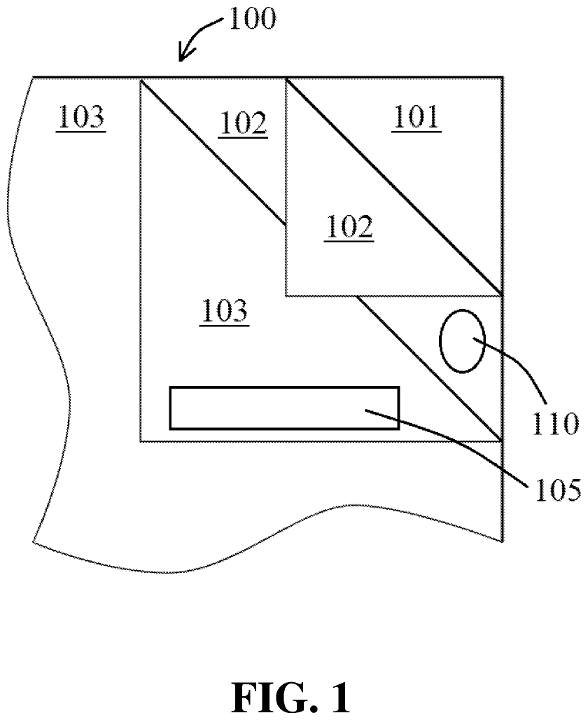

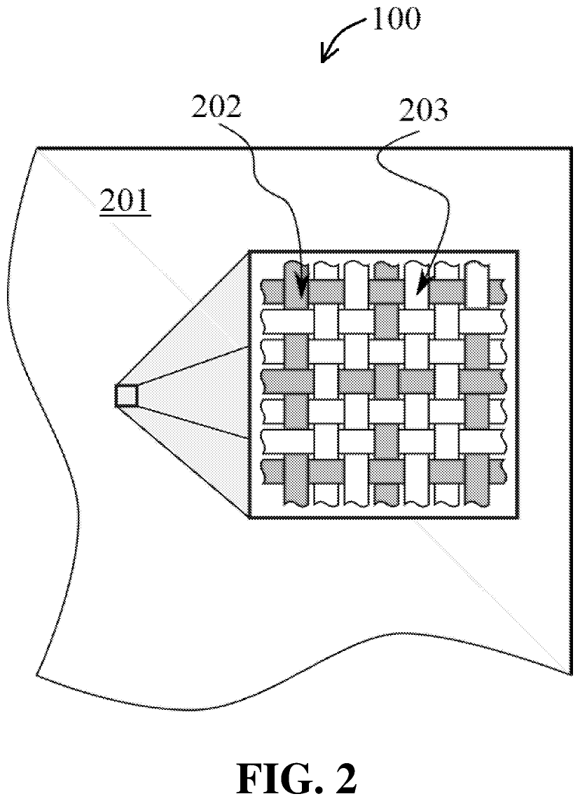

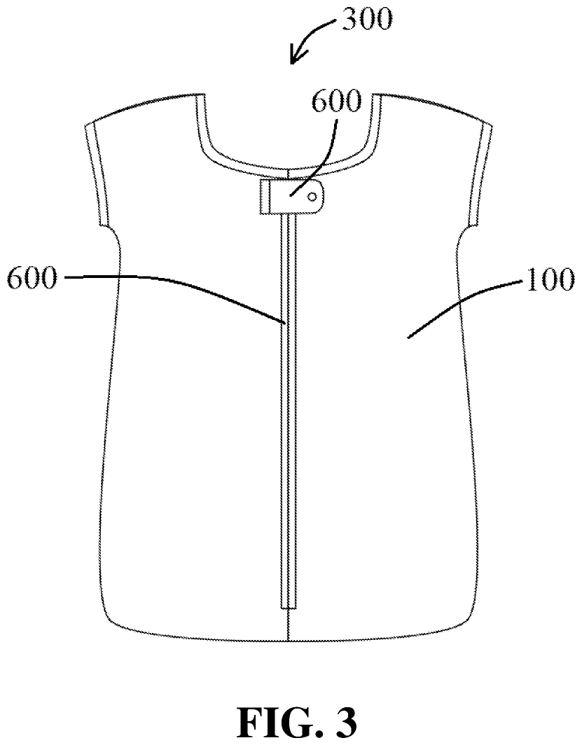

The present disclosure includes disclosure of a composite fabric (also referred to herein as a composite product) consisting of antimicrobial and water retentive materials. An exemplary embodiment is in the form of a three-layer fabric as shown in FIG. 1. An additional embodiment is a single layer fabric that has the water retentive material embedded in the fabric, as shown in FIG. 2. Single layer embodiments of the present disclosure, when formed into garments, maximize the breathability and comfort of the final garment. An exemplary embodiment of a garment is in the form of infant sleepwear, as shown in FIG. 3.

FIG. 1 depicts an exemplary composite product 100 of the present disclosure. As shown in FIG. 1, an exemplary composite product 100 of the present disclosure is generally configured as a fabric/cover having at least three layers, including, but not limited to, an inner layer 101, a middle layer 102, and an outer layer 103, each adjacent to one another as shown.

In such a three-layer fabric (composite product 100) embodiment, inner layer 101 is intended for placement closest to the user's/wearer's skin, so that middle layer 102 does not come into direct contact with the user's/wearer's skin. Middle layer 102, as described in further detail herein, is a liquid absorbing/retaining material, such as super absorbent polymer (SAP), which can absorb at least three times its weight in liquid (such as water, saline, or another liquid, for example), and hold on to the liquid in order to provide a high relative humidity for the skin. The thickness and pattern density of middle layer 102 can be modulated to control the skin surface hydration. An example of SAP is sodium polyacrylate [—CH₂—CH(CO₂Na)—]ₙ. An exemplary SAP of the present disclosure uses the tradename Gelok®.

As such, and in a three-layer composite product 100 embodiment such as shown in FIG. 1, inner layer 101 (or the layer closest to the user's skin) ensures that the skin does not come in direct contact with the water retention material (SAP, for example) of middle layer 102, while also becoming hydrated from the water vapor released from middle layer 102. Such a composite product 100 also does not act as a vector for causing infections. So to incorporate each of these properties into one overall composite product 100, inner layer 101, in at least one exemplary embodiment, comprises a smooth and breathable fabric/material that is antimicrobial (having antimicrobial properties). An example of a suitable (and potentially preferred) materials for inner layer 101 is Tencel®, which is the trade name for lyocell and modal fibers, which is a sustainable fabric generated from wood cellulose or viscose rayon (also known as “bamboo fabric”). Additionally, inner layer 101 can also comprise a natural dye configured to be used to enhance the antimicrobial properties of inner layer 101. A preferred natural dye is turmeric, which a natural compound which contributes antimicrobial protection to the fabric (inner layer 101 of composite product 100). Turmeric imparts a yellow color to the fabric that is dyed with this material. The use of aluminum sulfate (alum) as the mordant to fix the turmeric dye to the fabric (inner layer 101 of composite product 100) significantly adds to the antimicrobial properties of the fabric. Other water insoluble and/or soluble antibacterial materials (such as metal oxides and metallic ionic compounds, e.g. Zinc oxide, Magnesium oxide, Zinc Carbonate, Magnesium Carbonate), could also be used in connection with composite products of the present disclosure. Said antimicrobial elements can have antibacterial and/or antifungal properties, noting that, for example, such materials may be stearic acid/potassium stearate mixtures in such a ratio to achieve a skin friendly pH of 5.5-6.0, or such materials may be oleic acid/potassium oleate mixtures in such a ratio to achieve a skin friendly pH of 5.5-6.0, for example.

Middle layer 102, as referenced herein, is a liquid absorbing/retaining material, such as SAP, which can absorb at least three times its weight in liquid (such as water, saline, or another liquid, for example), and hold on to the liquid in order to provide a high relative humidity for the skin.

Outer layer 103, such as shown in FIG. 1, is configured to prevent bacteria and other contaminants from coming in contact with the skin to avoid any infections. Outer layer 103 will be hydrophobic (will comprise material having hydrophobic properties) to prevent evaporation and prolong the hydration time composite garment 100 can fully deliver to the skin of the user.

Inner layer 101, middle layer 102, and outer layer 103 of composite product can be adhered together to form one overall fabric layer (a single-layer composite product 100, such as shown in FIG. 1), as follows. In one embodiment, inner layer 101, middle layer 102, and outer layer 103 are sewn together, starting by cutting the three layers 101, 102, 103 to the same dimensions and sewing the three layers 101, 102, 103 simultaneously so to generate a single-layer composite product 100 as shown in FIG. 1. Alternatively, three layers 101, 102, 103 can be sewn separately, and assembled one at a time to make one composite product 100.

Layers 101, 102, 103 could also be combined to one another using a hook and loop fastener 105 (Velcro® for example), such as shown in FIG. 1, allowing for any of the three layers 101, 102, 103 to be removed as needed/desired. In particular, and for example, middle layer 102 can be removed so to allow replacement and/or washing of the inner layer 101 and/or the outer layer 103. These “detachable” features make the composite products 100, and garments 300 (discussed in further detail below) formed using composite products 100 of the present disclosure, reusable as desired.

An additional exemplary embodiment of a composite product of the present disclosure is shown in FIG. 2, which is in the form of a single layer fabric with the water retentive material (middle layer 102) woven into the fabric. As shown in FIG. 2, composite product 100 can form a single fabric layer 201, comprising at least liquid absorbing/retaining material 202 and antimicrobial material 203. SAP is commercially available in form of fiber (a super absorbent fiber (SAF), an exemplary liquid absorbing/retaining material 202), which can be interwoven between antimicrobial material 203, such as Tencel®, viscose rayon, or another suitable antimicrobial material 203). Liquid absorbing/retaining material 202 of the present disclosure can also comprise super absorbent laminate (SAL) or air-laid paper. SAF, in at least one embodiment, can have a fiber density of at least 1.4 g/ml. Exemplary SAFs of the present disclosure can also comprise at least one synthetic fiber (such as polyester), at least one natural fiber, or a mixture thereof. In addition to the varying the content and/or chemistry of the SAF, such an embodiment (as shown in FIG. 2) allows the producer of composite product 100 to change the ratio of SAF (liquid absorbing/retaining material) to the substrate fiber (antimicrobial material 203) in the knit for controlling the extent and duration of hydration delivered to the user's skin by composite product 100.

As noted above, FIG. 2 depicts an additional implementation of a composite product 100 of the present disclosure, in which the fiber form of SAP is interwoven with the substrate fiber to form a hydrating single fabric layer 201. A zoomed-in view to the level of individual fibers is shown in the inset. As shown therein, single fabric layer comprises at least liquid absorbing/retaining material 202 and antimicrobial material 203.

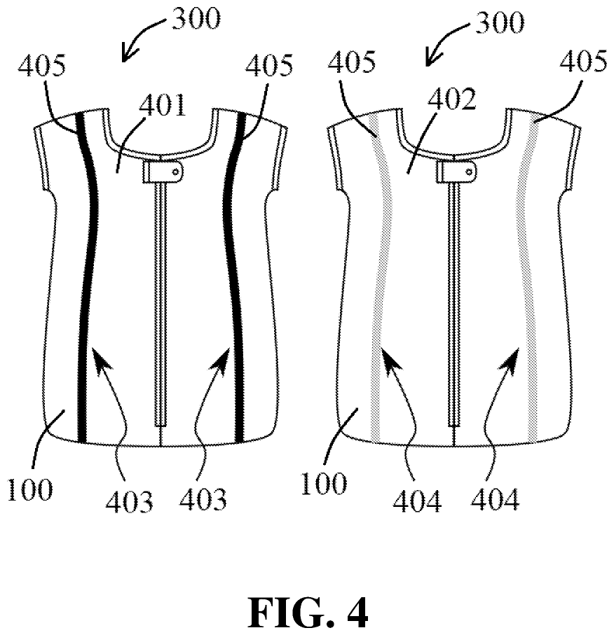

Exemplary composite products 100 of the present disclosure, regardless of configuration, can be configured as garments, or portions thereof, as described in further detail herein. FIGS. 3 and 4 show an exemplary garment 300 of the present disclosure, whereby garment 300 shown in FIG. 3 does not incorporate or comprise a composite product 100 of the present disclosure, and whereby garment 300 shown in FIG. 4 does incorporate a composite product 100 of the present disclosure therein.

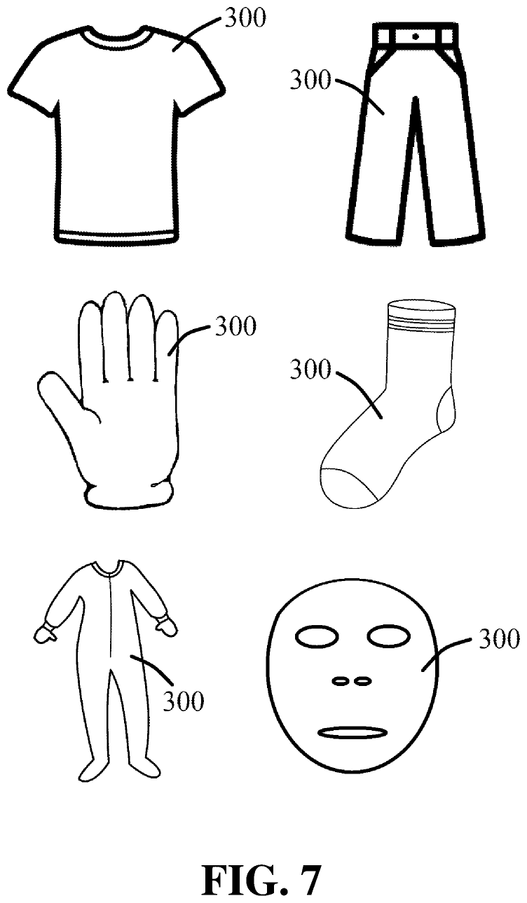

FIGS. 3, 4, and 6 show exemplary garment embodiments configured as infant sleepwear. However, exemplary garments of the present disclosure can comprise various other configurations, such as child and/or adult sleepwear, bodysuits, leg covers, arm covers, torso covers, hand covers, foot covers, face covers, etc., such as shown in FIG. 7. Bodysuit implementations, for example, are ideal for all-over body hydration. Leg, foot, arm, or hand covers, for example, can provide localized hydration. The covers can be designed to be adjustable using hook and loop closures, such as Velcro®.

The exemplary garments 300 shown in FIG. 4 are configured to report the hydration level of the garment 300 to user by using a hydrochromic dye. Garment 300 shown on the left side of FIG. 4 in a dehydrated or relatively dehydrated configuration (also referred to herein as a dehydrated garment 401), and garment 300 shown on the right side of FIG. 4 in a hydrated or relatively hydrated configuration (also referred to herein as a hydrated garment 402). Dyed portions 405 can be coupled to or otherwise woven or form part of garments 300 of the present disclosure, such that, for example, dyed portion 405 can be readily visible when garment 300 is dehydrated (shown in FIG. 4 in a dehydrated dye configuration 403), and can also be less visible (or invisible) when garment is fully or relatively hydrated (shown in FIG. 4 in a hydrated dye configuration). Hydration level indication of garment 300 can facilitate the proper use of garment 300 by the user. For example, should dyed portions 405 indicate that garment 300 is dehydrated or relatively dehydrated (in a in a dehydrated dye configuration 403), the user could soak garment 300, or spray it with water or another liquid, to rehydrate garment 300 before use or additional use. As noted above, FIG. 4 shows embodiments whereby the hydration level of the garment 300 can be reported to user by using a hydrochromic dye (part of dye portion(s) 405).

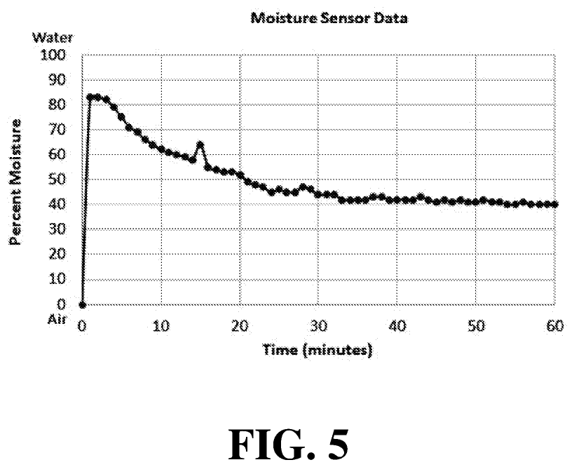

FIG. 5 shows moisture sensor data in connection with the moisture retention capabilities of an exemplary liquid absorbing/retaining material 202 of the present disclosure comprising Tencel® and Gelok® measured over a time period of one hour. As shown therein, said liquid absorbing/retaining material 202 releases moisture over time, less gradually over time as the moisture leaves the liquid absorbing/retaining material.

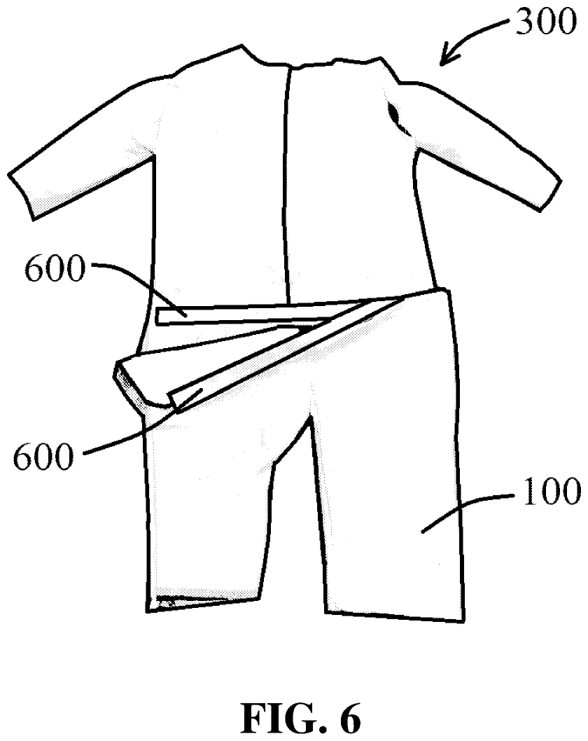

FIG. 6 shows an exemplary garment embodiment constructed using a composite product 100 of the present disclosure, in particular a three-layer composite product 100. Garment closures 600, including but not limited to hook and loop fastener (Velcro®) closures, are placed at one or more openings or access points to facilitate ease of wearing garment 300, ease of diaper replacement, and the like. Garments 300 of the present disclosure can also be made using single-layer composite products 100 of the present disclosure.

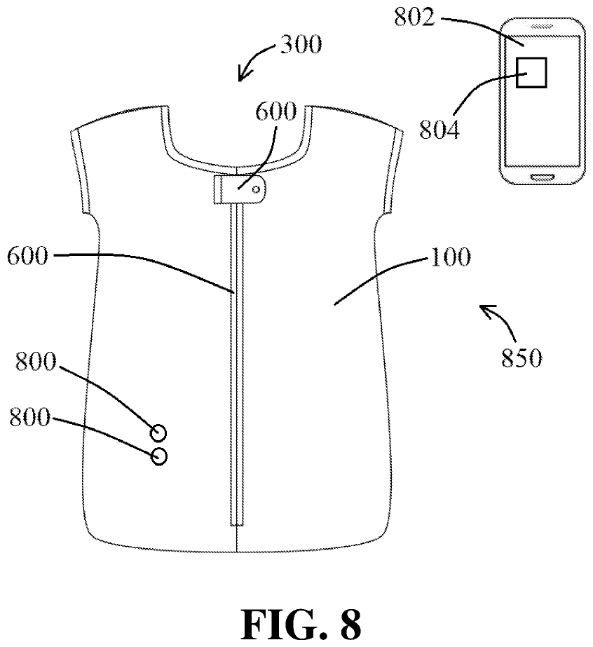

Exemplary garments 300 of the present disclosure can be fashioned also into a footed and mitted/gloved bodysuit, such as shown in the lower left of FIG. 8. In such an embodiment, garment 300 closures 600 can comprise soft and flexible sew-on Velcro® (an exemplary hook and loop fastener). The front closure 600 can extend from the neckline, down the torso, and then down the inner seam on one leg, as may be desired. The feet and hands of the garment 300, in embodiments having hand and foot coverings, can be ae attached with Velcro® (an exemplary hook and loop fastener) so that they may be removed. Two side closures can be present on the outer seams of both legs, extending from the waist to the ankle, as may be desired. A back closure can extend across the back, going from a left side to a right side, as may be desired. The back and side closures can be designed so that a diaper can be easily checked and changed. The design incorporating multiple closures 600 allows the clothing (garments 300) to be easy to put on, take off, and to change diapers, as may be desired.

Additional composite product 100 and/or garment 300 embodiments can comprise electronics configured to measure the hydration level of said composite product 100 and/or garment 300. SAP or SAF, as well as other liquid absorbing/retaining materials, have a property that causes them to swell with absorbed moisture. This property can be exploited to measure the hydration level of composite product 100. In at least one embodiment, and as shown in FIG. 8 composite products 100 of the present disclosure, including those configured as garments, can comprise electrodes or sensors 800 which can be woven or otherwise adhered onto/into composite product 100, whereby said electrodes or sensors 800, in at least one embodiment, are configured to measure the thickness of the fabric (composite product 100) using capacitance of the electrode-fabric-electrode structure as a proxy for the hydration level. Additionally, electrodes or sensors 800 configured as planar electrodes or sensors 800 and which are driven with a high frequency signal can measure the impedance of the fabric (composite product 100) itself to obtain a hydration measurement. This information can be wirelessly transmitted to a mobile device 802, such as shown in FIG. 8, where the information is stored and displayed to the user in the form of an application. An exemplary application 804 (a type/example of software) can be configured to log the amount of water retained and from this calculate the rate at which the water is lost and how long until the garment 300 will retain its skin hydration efficacy, for example. Based on this calculation, the application 804 could notify the user of the remaining time of garment 300 efficacy and give notifications for rehydration when required. An exemplary system 850 of the present disclosure, such as shown in FIG. 8, can comprise an exemplary material 100 and/or an exemplary garment 300 along with an exemplary mobile device 802.

Garments 300 of the present disclosure can designed with an inexpensive sensor (an exemplary electrode or sensor 800) configured to obtain and wirelessly relays data relating to the temperature and humidity on the skin of the person wearing the garment 300. To utilize the garment 300 in the caregiver mode, namely in a mode whereby garment 300 obtains and transmits data to a mobile device 802 of a caregiver, the caregiver can make at least four possible changes to the garment 300 on demand, as directed by the electrode(s) or sensor(s) 800:

1) When the skin is above desired temperature limits, (“too hot”), a layer is removed.

2) When the skin is below desired temperature limits, (“too cold”), a layer is added.

3) When the skin is above desired humidity limits, (“too wet”), a water permeable layer is replaced.

4) When the skin is below desired humidity limits, (“too dry”), a water impermeable layer is added.

This garment 300 embodiment gives the caregiver a mechanism to achieve passive control of temperature and humidity within desired limits for maximum comfort and control. Active control garments with electronic heaters and coolers are becoming available to the consumer, however these can be expensive and may not affordable by the average consumer. The advantage of passive control of temperature and humidity is that the simplicity of the design leads to less failures in operation, as having less parts to fail leads to greater safety and greater affordability of the garment 300.

In an exemplary multiple layer composite product 100 embodiment, an iron on patch 110, such as shown in FIG. 1, is placed at strategic places throughout the garment 300, such as near the end of the legs and the end of the arms, whereby a heating iron can be pressed on top of the garment 300 to accomplish a permanent bonding of one or more layers 101, 102, 103 to one another.

Accordingly, the present disclosure includes disclosure of a novel method of treating the condition of all over body severe eczema that is an improvement over existing methods of dealing with this disease. The design of the treatments referenced herein utilizes a comfortable article of clothing (an exemplary garment 300) that is made from a composite fabric (an exemplary composite product 100) with water retention and antimicrobial properties.

While various embodiments of products, garments, and systems and methods of using and forming the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A composite product, comprising:
a first material configured to retain liquid and release liquid vapor over time; and
a second material having antimicrobial properties;
wherein the first material and the second material are combined to form the composite product.

2. The composite product of claim 1, wherein the first material and the second material are woven together to form a single layer of material.

3. The composite product of claim 1, wherein the first material and the second material are combined by layering the first material on top of the second material to form a two-layered material.

4. The composite product of claim 1, further comprising:
a third material having hydrophobic properties; and
wherein the third material is combined with the first material and the second material to form the composite product.

5. The composite product of claim 4, wherein the first material, the second material, and the third material are combined by layering the first material on top of the second material, and layering the third material on top of the first material, to firm a three-layered material.

6. The composite product of claim 1, wherein the second material comprises lyocell and modal fibers.

7. The composite product of claim 1, wherein the second material comprises viscose rayon.

8. The composite product of claim 1, wherein the first material comprises a super absorbent polymer (SAP).

9. The composite product of claim 1, wherein the first material comprises a super absorbent fiber (SAF).

10. (canceled)

11. The composite product of claim 1, formed into a garment configured to cover at least part of a wearer's body.

12.-18. (canceled)

19. The composite product of claim 5, formed into a garment configured to cover part of a wearer's body.

20.-24. (canceled)

25. The composite product of claim 1, further comprising a dyed portion combined with the composite product.

26.-30. (canceled)

31. The composite product of claim 1, further comprising a quaternary ammonium compound with a silyl functional group derivatized onto the second material to provide the antimicrobial properties to the composite product.

32. The composite product of claim 1, further comprising one or more electrodes or sensors incorporated into the composite product.

33. (canceled)

34. (canceled)

35. The composite product of claim 1, wherein the antimicrobial properties of the second material are antibacterial properties and antifungal properties.

36. The composite product of claim 1, wherein the second material comprises a metal oxide or a metal ionic compound.

37. (canceled)

38. The composite product of claim 11, further comprising one or more electrodes or sensors incorporated into the composite product of the garment.

39. The composite product of claim 38, comprising part of a system, the system further comprising a mobile device in wireless communication with the one or more electrodes or sensors.

40. The composite product of claim 39, wherein the one or more electrodes is/are configured to obtain data relative to the garment and/or the wearer of the garment and configured to transmit said data to the mobile device.

41.-46. (canceled)

47. The composite product of claim 11, used to treat atopic dermatitis.

48. (canceled)
